(19) United States
(12) Patent Application Publication
(10) Pub. No.: US 2019/0005760 A1
(43) Pub. Date: Jan. 3, 2019

(54) DOOR SHEET OF VENDING MACHINE

(71) Applicant: SHANGHAI GEANT INDUSTRIAL CO., LTD, Shanghai (CN)

(72) Inventor: Qi ZHOU, Shanghai (CN)

(73) Assignee: SHANGHAI GEANT INDUSTRIAL CO., LTD, Shanghai (CN)

(21) Appl. No.: 15/749,785

(22) PCT Filed: Sep. 19, 2016
(86) PCT No.: PCT/CN2016/099285

§ 371 Date: Feb. 2, 2018

(30) Foreign Application Priority Data
Sep. 21, 2015 (CN) 201520734475.3

(51) Int. Cl. G07F 11/00

(52) U.S. Cl. CPC G07F 11/005

(57) ABSTRACT

The present utility model discloses a door sheet of a vending machine, including a door sheet body and, a goods outlet wherein an upper baffle is arranged above the goods outlet, and a lower baffle is arranged below the goods outlet. The door sheet further includes a motor, wherein the motor drives, through a transmission rod, the lower baffle to longitudinally move, and the upper baffle is connected to the door sheet body through an elastic device. The elastic device is a spring. The top end of the goods outlet is laterally provided with a photoelectric device. The photoelectric device is connected to the motor, and can make the motor stop running.

### CROSS REFERENCE TO RELATED APPLICATIONS

This application is the national phase entry of International Application No. PCT/CN2016/099285, filed on Sep. 19, 2016, which claims priority from the Chinese patent application no. 201520734475.3 filed on Sep. 21, 2015, the entire contents of which are incorporated herein by reference.

### TECHNICAL FIELD

The present invention relates to a vending machine, and in particular, a door sheet of a vending machine.

### BACKGROUND

Common vending machines have goods outlets, some outlets are isolated from unsold goods, and the unsold goods can be obtained through outlets of some vending machines. Such an outlet usually has a movable baffle, reasonable time is set, and after a user obtains sold goods through the outlet, the baffle is closed to prevent unsold goods from being taken away.

However, such a baffle has a defect, that is, the hand of a user who acts slowly or a user who does not know that the baffle will be closed is likely be pinched, causing inconveniences. The present patent is to resolve the foregoing problem.

### SUMMARY

The present utility model discloses a door sheet of a vending machine, including a door sheet body and a goods outlet, wherein an upper baffle is arranged above the goods outlet, and a lower baffle is arranged below the goods outlet. The door sheet further includes a motor, wherein the motor drives, through a transmission rod, the lower baffle to longitudinally move, and the upper baffle is connected to the door sheet body through an elastic device.

The elastic device is a spring, the length of the elastic device being larger than 5 cm.

The top end of the goods outlet is laterally provided with a photoelectric device. The photoelectric device is connected to the motor, and can make the motor stop running.

The present utility model can control the lower baffle to close the goods outlet, and therefore the palm of a user cannot be pinched, thereby facilitating the use by the user.

### BRIEF DESCRIPTION OF THE DRAWINGS

FIG. 1 is a front schematic diagram of a door sheet of a vending machine.

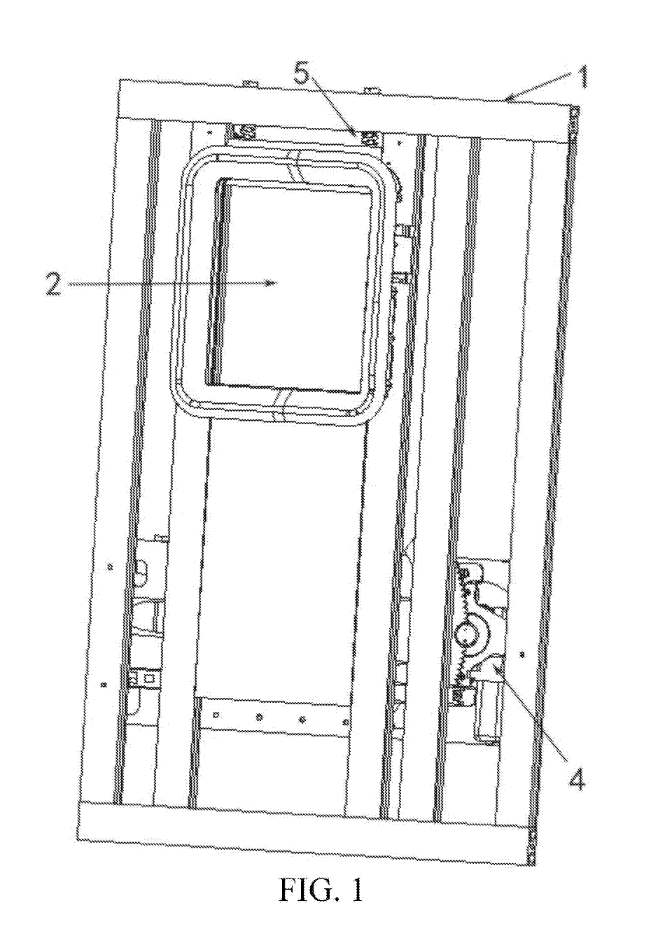

FIG. 2 is a back schematic diagram of a door sheet of a ending machine to lower baffle is not uplifted).

FIG. 3 is a back schematic diagram of a door sheet of a vending machine (a lower baffle is already uplifted).

FIG. 4 is an overall schematic diagram of a door sheet of a vending machine mounted on the vending machine.

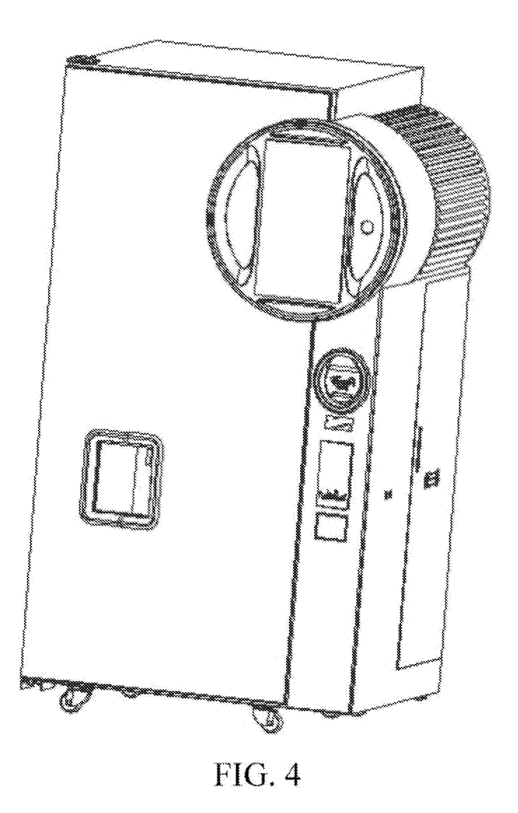

### DETAILED DESCRIPTION

The detailed description is made hereinbelow in conjunction with the drawings.

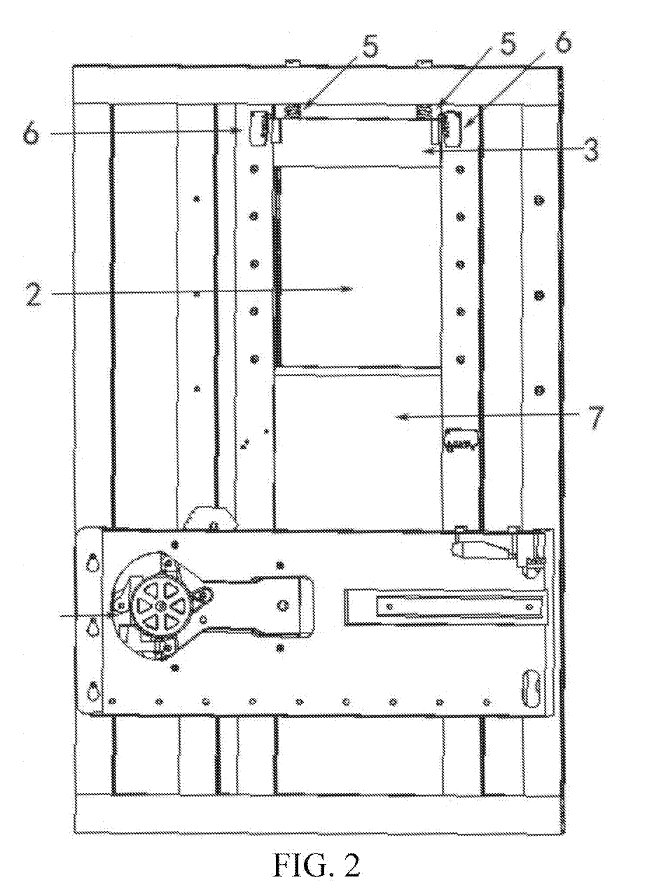

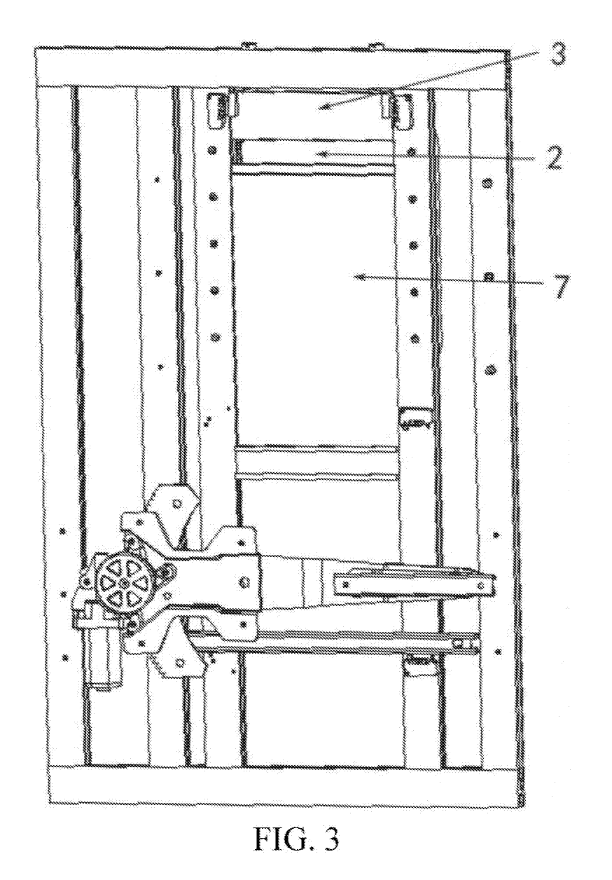

As shown in FIG. 2 and FIG. 3, a door sheet of a vending machine includes a door sheet body (1) and a goods outlet (2), wherein an upper baffle (3) is arranged above the goods outlet (2), and a lower baffle (7) is arranged below the goods outlet (2). The door sheet further includes a motor (4), wherein the motor (4) drives, through a transmission rod, the lower baffle (7) to longitudinally move, and the upper baffle (3) is connected to the door sheet body (1) through an elastic device (5).

The elastic device (5) is a spring, the length of the elastic device (5) being larger than 5 cm.

The top end of the goods outlet (2) is laterally provided with a photoelectric device (6), and the photoelectric device (6) is connected to the motor (4), and can make the motor (4) stop running.

Because of the arrangement of the elastic device, when the motor drives the transmission rod to move the lower baffle up to close the goods outlet, a hand that is not pushed out yet due to a slow action is pushed to be above the lower baffle. Because of the elastic device, the upper baffle is pushed up. Since the length of the elastic device is larger than 5 cm and larger than the width of a common palm, the palm of a user cannot be pinched.

On the other hand, the photoelectric device detects an area above the goods outlet, and when the photoelectric device detects that the hand of the user does not leave yet, the motor will be controlled by means of a circuit (not shown in the figures) to stop running.

The motor reverses, and after a certain time, a door will be automatically closed, so that burglary is avoided.

The content is only basic description under the concept of the present invention, and any equivalent changes made according to the technical solution of the present utility model should fall within the scope of protection of the present invention.

1. A door sheet of a vending machine, comprising a door sheet body, and a goods outlet, an upper baffle arranged above the goods outlet, a lower baffle arranged below the goods outlet, and a motor, wherein the motor drives the lower baffle through a transmission rod to move longitudinally, and wherein the upper baffle is connected to the door sheet body through an elastic device.

2. The door sheet of a vending machine of claim 1, wherein the elastic device is a spring, and the length of the elastic device is larger than 5 cm.

3. The door sheet of a vending machine of claim 1, wherein, a top end of the goods outlet is laterally provided with a photoelectric device, and the photoelectric device is connected to the motor, and is configured to stop the motor.

4. The door sheet of a vending machine of claim 2, wherein, a top end of the goods outlet is laterally provided with a photoelectric device, and the photoelectric device is connected to the motor, and is configured to stop the motor.
